(19) United States
(12) Patent Application Publication
(10) Pub. No.: US 2018/0322042 A1
(43) Pub. Date: Nov. 8, 2018

(54) MEMORY SYSTEM AND OPERATING METHOD OF MEMORY SYSTEM

(71) Applicant: SK hynix Inc., Gyeonggi-do (KR)

(72) Inventor: Eun-Soo JANG, Gyeonggi-do (KR)

(21) Appl. No.: 15/895,605

(22) Filed: Feb. 13, 2018

(30) Foreign Application Priority Data
May 8, 2017 (KR) 10-2017-0057256

(51) Int. Cl. G06F 12/02; G06F 3/06

(52) U.S. Cl. CPC G06F 12/0246; G06F 3/0604; G06F 3/0623; G06F 2212/7201; G06F 3/061; G06F 3/0679; G06F 3/0658

(57) ABSTRACT

In accordance with an embodiment of the present invention, a memory system may include a memory device suitable for storing data; and a controller including a first memory, wherein the controller is suitable for: performing system operations to the memory device and the controller; storing meta-data corresponding to the system operations into the memory device; storing the meta-data stored in the memory device into one or more between the first memory and a second memory included in a host; and identifying the meta-data from the memory device, the first memory and the second memory when performing the system operations.

### CROSS-REFERENCE TO RELATED APPLICATIONS

The present application claims priority under 35 U.S.C. § 119(a) to Korean Patent Application No. 10-2017-0057256 filed on May 8, 2017, the disclosure of which is incorporated herein by reference in its entirety.

### BACKGROUND

### 1. Field

Various exemplary embodiments of the present invention relate to a memory system capable of efficiently managing data, and an operating method thereof.

### 2. Description of the Related Art

The computer environment paradigm has changed to ubiquitous computing systems that can be used anytime and anywhere. That is, use of portable electronic devices such as mobile phones, digital cameras, and notebook computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSD).

### SUMMARY

Various embodiments of the present invention are directed to a memory system capable of efficiently processing data and operating method thereof.

In accordance with an embodiment of the present invention, a memory system may include a memory device suitable for storing data; and a controller including a first memory, wherein the controller is suitable for: performing system operations to the memory device and the controller; storing meta-data corresponding to the system operations into the memory device; storing the meta-data stored in the memory device into one or more between the first memory and a second memory included in a host; and identifying the meta-data from the memory device, the first memory and the second memory when performing the system operations.

When performing first system operations among the system operations, the controller is suitable for identifying first meta-data corresponding to the first system operations from the first memory; and identifying, when the first meta-data is not identified from the first memory, the first meta-data from the second memory.

The controller is suitable for, when the first meta-data is not identified from the second memory, reading the first meta-data from the memory device and storing the first meta-data into the first memory and the second memory.

The controller is suitable for reading from the second memory the first meta-data identified from the second memory, and storing the first meta-data into the first memory.

The controller is suitable for reading whole meta-segments or partial meta-segments required to be identified for performing the first system operations among meta-segments of the first meta-data according to a size of the first meta-data, and storing the read meta-segments into the first memory or the second memory.

The controller is suitable for performing the first system operations according to the first meta-data after identifying the first meta-data from the first memory or the second memory.

The controller is suitable for: updating the first meta-data according to a result of performing the first system operations; and storing the updated first meta-data into the memory device and one or more between the first memory and the second memory.

The controller is suitable for storing the meta-data into one or more between the first memory and the second memory according to one or more among types, characteristics, usage frequencies and sizes of the meta-data.

The meta-data includes one or more among map data, count information, table information, meta-information, statistical information and one-time usage frequency meta-data.

The controller is suitable for: encrypting the meta-data and storing the encrypted meta-data into the second memory; and identifying the encrypted meta-data stored in the second memory by decrypting the encrypted meta-data.

In accordance with an embodiment of the present invention, an operating method of a memory system may include performing system operations to a memory device suitable for storing data and a controller of the memory device; and storing meta-data corresponding to the system operations into the memory device, and storing the meta-data stored in the memory device into one or more between a first memory included in the controller and a second memory included in a host, wherein the performing of the system operations includes identifying the meta-data from the memory device, the first memory and the second memory.

The performing of the system operations may further include, when performing first system operations among the system operations: identifying first meta-data corresponding to the first system operations from the first memory; and identifying, when the first meta-data is not identified from the first memory, the first meta-data from the second memory.

The performing of the system operations may further include, when the first meta-data is not identified from the second memory, reading the first meta-data from the memory device and storing the first meta-data into the first memory and the second memory.

The performing of the system operations may further include, reading from the second memory the first meta-data identified from the second memory, and storing the first meta-data into the first memory.

The performing of the system operations may further include, reading whole meta-segments or partial meta-segments required to be identified for performing the first system operations among meta-segments of the first meta-data according to a size of the first meta-data, and storing the read meta-segments into the first memory or the second memory.

The performing of the system operations may further include, performing the first system operations according to the first meta-data after identifying the first meta-data from the first memory or the second memory.

The performing of the system operations may further include, updating the first meta-data according to a result of performing the first system operations; and storing the updated first meta-data into the memory device and one or more between the first memory and the second memory.

The storing of the meta-data may include storing the meta-data into one or more between the first memory and the second memory according to one or more among types, characteristics, usage frequencies and sizes of the meta-data.

The meta-data may include one or more among map data, count information, table information, meta-information, statistical information and one-time usage frequency meta-data.

The storing of the meta-data may include encrypting the meta-data and storing the encrypted meta-data into the second memory, and the identifying of the meta-data includes identifying the encrypted meta-data stored in the second memory by decrypting the encrypted meta-data.

In accordance with an embodiment of the present invention, a data processing system may include a memory device storing meta-data related to a system operation; a controller suitable for controlling the memory device to perform the system operation according to the meta-data loaded from the memory device onto a first memory included therein; and a host including a second memory shared with the controller and suitable for requesting to the controller a memory operation, wherein the controller is further suitable for using the second memory as a cache memory for the meta-data while in operation.

### BRIEF DESCRIPTION OF THE DRAWINGS

FIG. 1 is a block diagram illustrating a data processing system including a memory system, in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIGS. 5 to 7 illustrate an example of a memory system performing a plurality of system operations in accordance with an embodiment of the present invention.

FIG. 8 is a flowchart illustrating an operation of processing meta-data regarding a plurality of system operations in the memory system in accordance with the embodiment of the present invention.

FIGS. 9 to 17 are diagrams schematically illustrating application examples of a data processing system, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

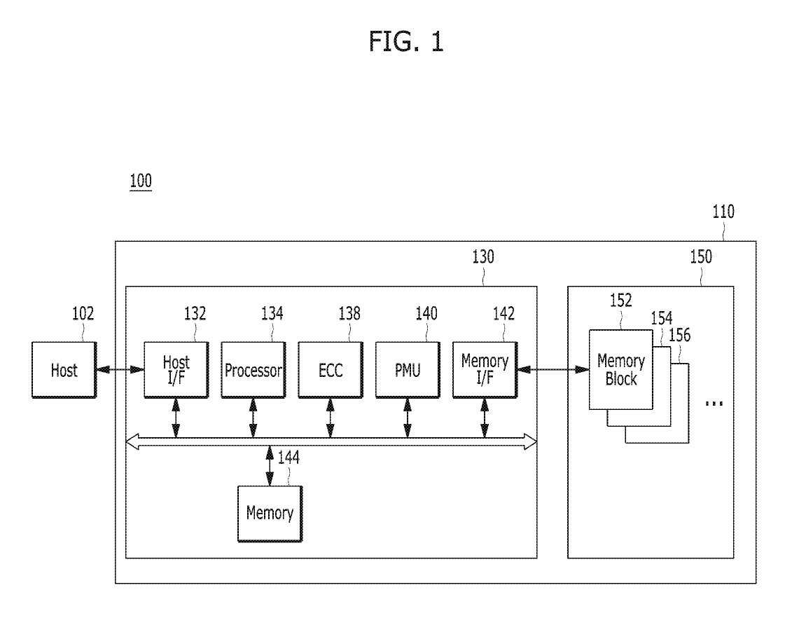

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, a portable electronic device such as a mobile phone, an MP3 player and a laptop computer or an electronic device such as a desktop computer, a game player, a TV, a projector and the like.

The memory system 110 may operate in response to a request from the host 102, and in particular, store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and a static RAM (SRAM) and nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory.

The memory system 110 may include a memory device 150 which stores data to be accessed by the host 102, and a controller 130 which may control storage of data in the memory device 150.

The controller 130 and the memory device 150 may be integrated into a single semiconductor device, which may be included in the various types of memory systems as exemplified above.

The memory system 110 may be configured as part of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3D television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various component elements configuring a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 to 156, each of the memory blocks 152 to 156 may include a plurality of pages. Each of the pages may include a plurality of memory cells to which a plurality of word lines (WL) are electrically coupled.

The controller 130 may control overall operations of the memory device 150, such as read, write, program and erase operations. For example, the controller 130 of the memory system 110 may control the memory device 150 in response to a request from the host 102. The controller 130 may provide the data read from the memory device 150, to the host 102, and/or may store the data provided from the host 102 into the memory device 150.

The controller 130 may include a host interface (I/F) unit 132, a processor 134, an error correction code (ECC) unit 138, a power management unit (PMU) 140, a memory interface (I/F) unit 142 such as a NAND flash controller (NFC) and a memory 144 all operatively coupled via an internal bus.

The host interface unit 132 may process commands and data provided from the host 102, and may communicate with the host 102 through at least one of various interface protocols such as universal serial bus (USB), multimedia card (MMC), peripheral component interconnect-express (PCI-E), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, modules, systems or devices for the error correction operation.

The PMU 140 may provide and manage power of the controller 130.

The memory interface unit 142 may serve as a memory/storage interface between the controller 130 and the memory device 150 to allow the controller 130 to control the memory device 150 in response to a request from the host 102. The memory interface unit 142 may generate a control signal for the memory device 150 and process data to be provided to the memory device 150 under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. The controller 130 may provide data read from the memory device 150 to the host 102, may store data provided from the host 102 into the memory device 150. The memory 144 may store data required for the controller 130 and the memory device 150 to perform these operations.

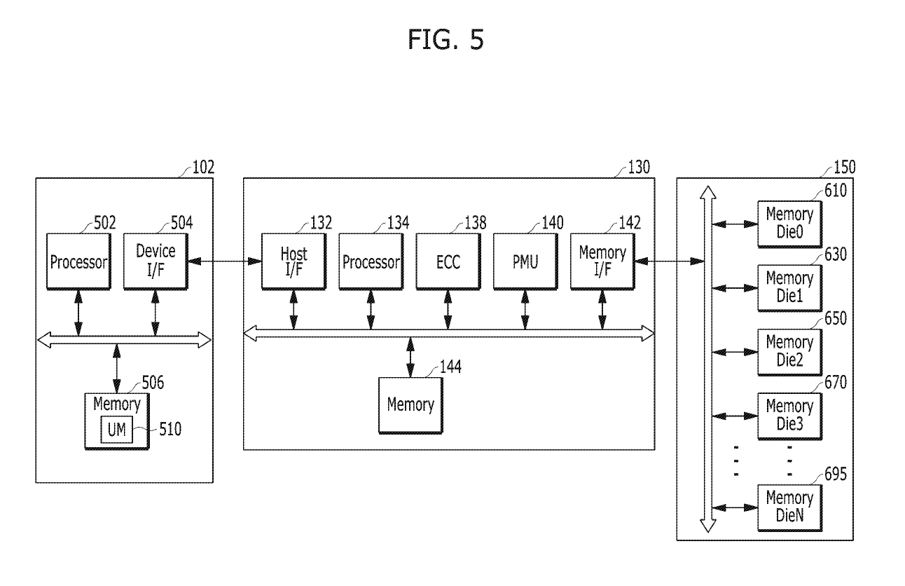

The memory 144 may include a mailbox for storing data for communication between a plurality of processors (See FIG. 5).

The memory 144 may be implemented with a volatile memory. The memory 144 may be implemented with a static random access memory (SRAM) or a dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware, which is referred to as a flash translation layer (FTL), to control the general operations of the memory system 110.

A FTL may perform an operation as an interface between the host 102 and the memory device 150. The host 102 may request to the memory device 150 write and read operations through the FTL.

The FTL may manage operations of address mapping, garbage collection, wear-leveling and so forth. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data into another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

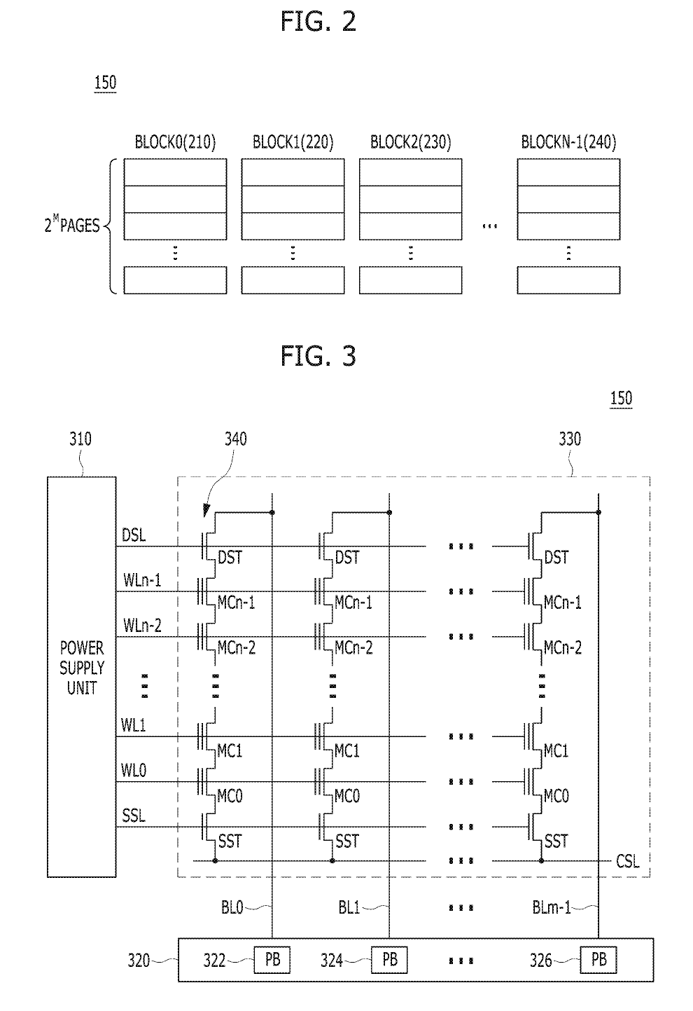

FIG. 2 is a schematic diagram illustrating the memory device 150.

Referring to FIG. 2, the memory device 150 may include the plurality of memory blocks BLOCK 0 to BLOCKN−1, and each of the blocks BLOCK 0 to BLOCKN−1 may include a plurality of pages, for example, 2^{m} pages, the number of which may vary according to circuit design. The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating a memory block 330 in the memory device 150.

Referring to FIG. 3, the memory block 330 which corresponds to any of the plurality of memory blocks 152 to 156.

Referring to FIG. 3, the memory block 152 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured by single level cells (SLC) each of which may store 1 bit of information, or by multi-level cells (MLC) each of which may store data information of a plurality of bits. The strings 340 may be electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 only shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A Power supply unit 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The Power supply unit 310 may perform a voltage generating operation under the control of a control circuit (not shown). The Power supply unit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

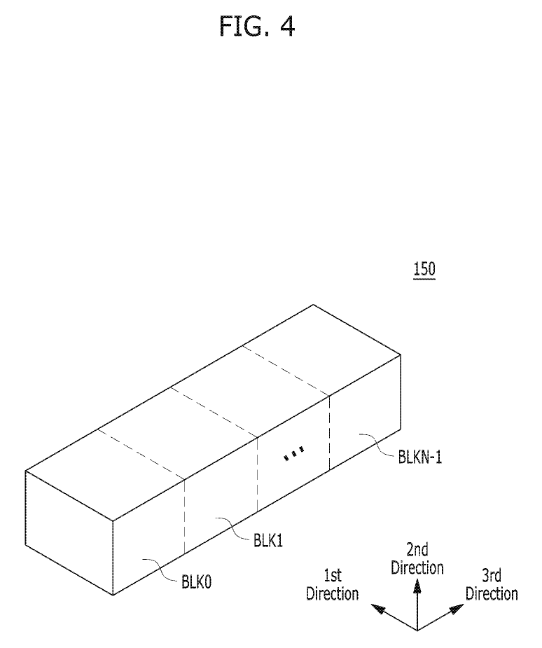

FIG. 4 is a schematic diagram illustrating a 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure).

FIGS. 5 to 7 illustrate an example of a memory system performing a plurality of system operations in accordance with an embodiment of the present invention. In this embodiment of the present invention, for the sake of convenience in description, described will be process of meta-data for performing a plurality of system operations such as foreground operations including a plurality of command operations for a plurality of commands provided from the host 102; background operations including a garbage collection operation, a wear-leveling operation, a map flush operation, a bad block management operation, and so forth; and other operations like a booting operation, an initialization operation, a trim operation, and so forth when the memory system 110 illustrated in FIG. 1 performs the plurality of system operations.

In accordance with an embodiment of the present invention, during such plurality of system operations, the memory system 110 may identify the meta-data corresponding to the system operations, perform the system operations according to the meta-data, and update and store the meta-data according to result of performing the system operations.

In accordance with an embodiment of the present invention, the meta-data may be stored in the memory 144 of the controller 130 or a memory of the host 102 as well as the memory device 150 of the memory system 110 according to result of performing the system operations. During such plurality of system operations, the memory system 110 may identify the meta-data corresponding to the system operations from the memory 144 of the controller 130 or a memory of the host 102, and identify the meta-data corresponding to the system operations from the memory device 150 of the memory system 110 when the memory system 110 cannot identify the meta-data corresponding to the system operations from the memory 144 of the controller 130 or the memory of the host 102.

In accordance with an embodiment of the present invention, during such plurality of system operations, the controller 130 may identify the meta-data corresponding to the system operations by first searching the memory 144 of the controller 130. When the meta-data is not stored in the memory 144 of the controller 130, the controller 130 may identify the meta-data corresponding to the system operations by secondly searching the memory of the host 102. When the meta-data is not stored in the memory of the host 102, the controller 130 may identify the meta-data corresponding to the system operations by thirdly searching the memory device 150.

When the meta-data is found in the memory device 150 since the meta-data is not stored in the memory 144 of the controller 130 or the memory of the host 102, the controller 130 may read and store the found meta-data into the memory 144 of the controller 130 or the memory of the host 102. When the meta-data is found in the memory of the host 102 since the meta-data is not stored in the memory 144 of the controller 130, the controller 130 may control performing the system operations according to the found meta-data or may read and store the found meta-data into the memory 144 of the controller 130. When the meta-data is found in the memory 144 of the controller 130, the controller 130 may control performing the system operations according to the found meta-data. As described above, the controller 130 may update and store the meta-data according to result of performing the system operations into the memory 144 of the controller 130 or the memory of the host 102 as well as the memory device 150.

Herein, it is assumed for the sake of convenience in description that the controller 130 controls the memory device 150 to perform the system operations in the memory system 110. In an embodiment, the processor 134 included in the controller 130 may control the memory device 150 to perform the system operations through the FTL. In an embodiment, the processor 134 may search and identify the meta-data corresponding to the system operations and may update and store the meta-data through the FTL according to result of performing the system operations. The meta-data may include all the other information and data except for user data provided along with a plurality of commands from the host 102.

In an embodiment, the meta-data may include a first map data including logical to physical (L2P) information (hereinafter, referred to as logical information) or mapping information (also referred to as L2P map table or L2P map list) between a logical address and a physical address of the data stored in the memory device 150. For example, the meta-data may include a second map data including logical to physical (L2P) information (hereinafter, referred to as physical information) or mapping information (also referred to as P2L map table or P2L map list) between the logical address and the physical address of the data stored in the memory device 150. For example, the meta-data may include a third map data having a map table or a map list for the map data. The meta-data may include the third map data having a map table or a map list for the first map data.

In an embodiment, the meta-data may include count data having count information according to performing the system operations of the memory system 110. The count information may include count information according to performing the system operations of the memory system 110. For example, the count information may include count information according to performing a plurality of command operations of the memory system 110 such as a read count according to performing a plurality of read operations, a program count according to performing a plurality of program operations, an erase count according to performing a plurality of erase operations as well as a count of valid pages in a plurality of memory blocks included in the memory device 150 according to performing the plurality of command operations.

In an embodiment, the meta-data may include table data including table information according to performing the system operations. The table information may correspond to the system operations of the memory system 110 and may represent memory blocks included in the memory device 150 as a result of performing the system operations. The table information may include a bitmap table (e.g., a page bitmap table of valid and invalid pages in a plurality of memory blocks) as a result of performing the system operations or a bitmap table as a result of a program operation, read operation and map data update operation. In an embodiment, the table information may include a map table of offsets between program operations or read operations and map data update operations. For example, the table information may include a map table (e.g., an open block number segment map table or a hash table) indicating an update operation to map data according to a read command or indicating storage location of map data corresponding to a read command as offset information due to difference between a time point of programming user data into the memory device 150 and a time point of updating map data according to the program operation of user data. In an embodiment, the table information may include a map table of super memory blocks formed by grouping a plurality of memory blocks included in the memory device 150. For example, the table information may include a super memory block map table, a map table (e.g., a diff table) as a result of performing a bad block management operation to the super memory blocks and so forth.

In an embodiment, the meta-data may include meta-information of an abnormal operation and an error correction operation to memory blocks of the memory device 150. The meta-information may include meta-data of performing error handling operation, a read reclaim operation, a wear-leveling operation and a voltage management operation (e.g., a low voltage detection operation) to memory blocks of the memory device 150.

In an embodiment, the meta-data may include statistical data including statistical information of the memory system 110. For example, the statistical information may include count information indicating erase counts (particularly, maximum, minimum and average erase counts) of memory blocks included in the memory device 150 as a result of erase operations, count information indicating numbers of bad memory blocks and normal memory blocks among memory blocks included in the memory device 150, count information indicating a number of read reclaim operations to memory blocks included in the memory device 150, count information indicating a number of uncorrectable error correction codes (UECC) according to performing error correction operations with an error correction code, count information indicating a number of power-offs (particularly, sudden power offs) of the memory system 110, count information indicating an amount of program data as a result of program operations to the memory device 150 and an amount of read data as a result of read operations to the memory device 150 and count information indicating a number of returns from a voltage management operation (e.g., a number of low voltage detection operations).

In an embodiment, the meta-data may include one-time meta-data for one-time system operations of the memory system 110. The one-time meta-data may include precoding information of a precoding status update operation of the memory system 110, firmware version information due to compatibility and matching between firmware versions of the memory system 110, and so forth.

In accordance with an embodiment of the present invention, during such plurality of system operations, the controller 130 may identify the meta-data corresponding to the system operations by searching the memory 144 of the controller 130, the memory of the host 102 and memory blocks of the memory device 150, perform the system operations according to the meta-data, and update and store the meta-data into the memory 144 of the controller 130, the memory of the host 102 or the memory blocks of the memory device 150 according to a result of performing the system operations.

In accordance with an embodiment of the present invention, the controller 130 may store the meta-data into the memory 144 of the controller 130 or the memory of the host 102 as well as memory blocks of the memory device 150 according to types, characteristics, usage frequencies and sizes of the meta-data, identify the meta-data corresponding to the system operations by searching the memory 144 of the controller 130 and the memory of the host 102 and identify the meta-data corresponding to the system operations by searching memory blocks of the memory device 150 when the meta-data is not searched in the memory 144 of the controller 130 and the memory of the host 102.

In accordance with an embodiment of the present invention, for the sake of convenience in description, the meta-data may be classified into first to fourth meta-data according to types, characteristics, usage frequencies and sizes of the meta-data.

The first meta-data may be of a short term, have a less size than a threshold size range and of high usage frequency. The third meta-data may be of a long term, have a greater size than the threshold size range and of low usage frequency. The second meta-data may be of a medium term and have a size in the threshold size range. The fourth meta-data may be of a one-time usage frequency.

In accordance with an embodiment of the present invention, the controller 130 may store the first meta-data into the memory 144 thereof as well as memory blocks of the memory device 150. During first system operations corresponding to the first meta-data, the controller 130 may identify the first meta-data from the memory 144 thereof, perform the first system operations, and update and store the first meta-data into the memory 144 thereof as well as memory block of the memory device 150 according to a result of performing the first system operations.

In accordance with an embodiment of the present invention, the controller 130 may store the second meta-data into the memory of the host 102 as well as memory blocks of the memory device 150. During second system operations corresponding to the second meta-data, the controller 130 may identify the second meta-data from the memory of the host 102, perform the second system operations, and update and store the second meta-data into the memory of the host 102 as well as memory block of the memory device 150 according to a result of performing the second system operations.

In accordance with an embodiment of the present invention, the controller 130 may store the third meta-data into memory blocks of the memory device 150. During third system operations corresponding to the third meta-data, the controller 130 may identify the third meta-data from the memory 144 of the controller 130 and the memory of the host 102 by reading the third meta-data from memory blocks of the memory device 150 and loading the read third meta-data onto the memory 144 of the controller 130 and the memory of the host 102, perform the third system operations, and update and store the third meta-data into memory block of the memory device 150 according to a result of performing the third system operations.

In accordance with an embodiment of the present invention, the controller 130 may store the fourth meta-data into memory blocks of the memory device 150. During fourth system operations corresponding to the fourth meta-data, the controller 130 may identify the fourth meta-data from the memory 144 of the controller 130 and the memory of the host 102 by reading the fourth meta-data from memory blocks of the memory device 150 and loading the read fourth meta-data onto the memory 144 of the controller 130 and the memory of the host 102, and perform the fourth system operations. In accordance with an embodiment of the present invention, the controller 130 may not update the fourth meta-data since the fourth meta-data is of the one-time usage frequency.

In accordance with an embodiment of the present invention, during such plurality of system operations, the controller 130 may identify the meta-data corresponding to the system operations by searching the meta-data corresponding to the system operations from the memory 144 of the controller 130, the memory of the host 102 and memory blocks of the memory device 150, perform the system operations according to the meta-data, and update and store the meta-data into the memory 144 of the controller 130, the memory of the host 102 or the memory blocks of the memory device 150 according to a result of performing the system operations.

In accordance with an embodiment of the present invention, the controller 130 may randomize or scramble the meta-data, which is to be stored into the memory of the host 102, for encryption of the meta-data while storing the meta-data into the memory of the host 102.

In accordance with an embodiment of the present invention, data of the memory system 110 may be stored in the memory of the host 102 thereby expanding memory space of the memory system 110. In accordance with an embodiment of the present invention, memory space for the controller 130 may be expanded from the memory 144 thereof to the memory of the host 102. Accordingly, operation performance of the memory system 110 may be improved.

In accordance with an embodiment of the present invention, data of the memory system 110 may be secured through encryption of data to be stored in the memory of the host 102. Accordingly, reliability and security of the memory system 110 may be improved. Hereafter, performing the system operation by the memory system 110 in accordance with the embodiments of the present invention is described in detail with reference to FIGS. 5 to 7.

Referring to FIG. 5, during a plurality of system operations including foreground operations such as a plurality of command operations in response to a plurality of commands provided from the host 102 and background operations, the controller 130 may identify meta-data corresponding to the system operations, performs the system operations according to the meta-data, and update and store the meta-data into memory blocks included in a plurality of dies 610, 630, 650, 670, 695 of the memory device 150 according to a result of performing the system operations. In accordance with an embodiment of the present invention, the controller 130 may store the meta-data into the memory 144 of the controller 130 or memory 506 of the host 102, particularly a unified memory (UM) 510 in the memory 506 of the host 102, as well as memory blocks included in a plurality of dies 610, 630, 650, 670, 695 of the memory device 150 according to types, characteristics, usage frequencies and sizes of the meta-data.

In accordance with an embodiment of the present invention, the host 102 may include a processor 502, the memory 506 and a device interface unit 504. The processor 502 may control overall operations of the host 102. The processor 502 may control the host 102 to provide the memory system 110 with commands representing user requests so that the memory system 110 performs command operations in response to commands representing user requests. The processor 102 may be implemented with a microprocessor or a central processing unit (CPU).

The memory 506 may be a main memory or a system memory of the host 102. The memory 506 may be adapted to store data for driving the host 102. The memory 506 may be divided into a memory region for host adapted to store data regarding operations of the host 102 and a memory region (i.e., the UM 510) for device adapted to store data regarding operations of the memory system 110. The memory region for host of the memory 506 may be a system memory region for the host 102 and may be adapted to store data or program information regarding a file system or an operation system of the host 102. The memory region for device or the UM 510 may be adapted to store data or information regarding operations of the memory system 110 during background operations and foreground operations such as command operations of the memory system 110 in response to commands provided from the host 102. The memory 506 may be implemented with a volatile memory such as a static random access memory (SRAM) or a dynamic random access memory (DRAM).

The device interface unit 504 may be a host controller interface (HCI) and may be adapted to process a command and data of the host 102, and may communicate with the memory system 110 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI), integrated drive electronics (IDE) and mobile industry processor interface (MIPI).

In accordance with an embodiment of the present invention, the controller 130 may classify the meta-data into first to fourth meta-data according to types, characteristics, usage frequencies and sizes of the meta-data and may store the meta-data into the memory 144 of the controller 130 or the UM 510 of the host 102 as well as memory blocks of the memory device 150 according to types, characteristics, usage frequencies and sizes of the meta-data.

The first meta-data may be of a short term, have a less size than a threshold size range and of high usage frequency. The third meta-data may be of a long term, have a greater size than the threshold size range and of low usage frequency. The second meta-data may be of a medium term and have a size in the threshold size range. The fourth meta-data may be of a one-time usage frequency. The first meta-data may include the map data, the count information, the table information, and so forth. The second meta-data may include the meta-information. The third meta-data may include the statistical information. The fourth meta-data may include the one-time meta-information.

In accordance with an embodiment of the present invention, the controller 130 may store the first meta-data into the memory 144 thereof as well as memory blocks of the memory device 150. During first system operations corresponding to the first meta-data, the controller 130 may identify the first meta-data from the memory 144 thereof, perform the first system operations, and update and store the first meta-data into the memory 144 thereof as well as memory block of the memory device 150 according to a result of performing the first system operations.

In accordance with an embodiment of the present invention, the controller 130 may store the second meta-data into the UM 510 of the host 102 as well as memory blocks of the memory device 150. During second system operations corresponding to the second meta-data, the controller 130 may identify the second meta-data from the UM 510 of the host 102, perform the second system operations, and update and store the second meta-data into the UM 510 of the host 102 as well as memory block of the memory device 150 according to a result of performing the second system operations.

In accordance with an embodiment of the present invention, the controller 130 may store the third meta-data into memory blocks of the memory device 150. During third system operations corresponding to the third meta-data, the controller 130 may identify the third meta-data from the memory 144 of the controller 130 and the UM 510 of the host 102 by reading the third meta-data from memory blocks of the memory device 150 and loading the read third meta-data onto the memory 144 of the controller 130 and the UM 510 of the host 102, perform the third system operations, and update and store the third meta-data into memory block of the memory device 150 according to a result of performing the third system operations.

In accordance with an embodiment of the present invention, the controller 130 may store the fourth meta-data into memory blocks of the memory device 150. During fourth system operations corresponding to the fourth meta-data, the controller 130 may identify the fourth meta-data from the memory 144 of the controller 130 and the UM 510 of the host 102 by reading the fourth meta-data from memory blocks of the memory device 150 and loading the read fourth meta-data onto the memory 144 of the controller 130 and the UM 510 of the host 102, and perform the fourth system operations. In accordance with an embodiment of the present invention, the controller 130 may not update the fourth meta-data since the fourth meta-data is of the one-time usage frequency.

In accordance with an embodiment of the present invention, the controller 130 may randomize or scramble the meta-data, which is to be stored in the UM 510 of the host 102, for encryption of the meta-data while storing the meta-data into the UM 510 of the host 102. In accordance with an embodiment of the present invention, the controller 130 may de-randomize or de-scramble the meta-data for decryption of the meta-data stored in the UM 510 of the host 102 while identifying the meta-data from the UM 510 of the host 102.

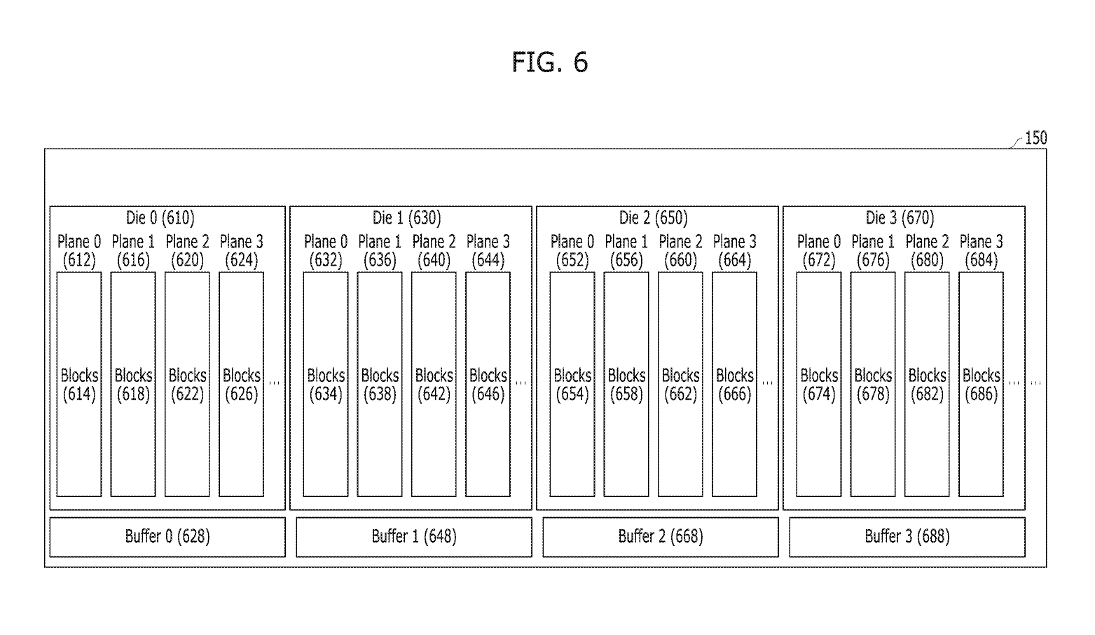

Referring to FIG. 6, the memory device 150 may include a plurality of memory dies, e.g., a memory die 0 610, a memory die 1 630, a memory die 2 650, and a memory die 3 670. Each of the memory dies 610, 630, 650 and 670 may include a plurality of planes. For example, the memory die 0 610 may include a plane 0 612, a plane 1 616, a plane 2 620 and a plane 3 624. The memory die 1 630 may include a plane 0 632, a plane 1 636, a plane 2 640 and a plane 3 644. The memory die 2 650 may include a plane 0 652, a plane 1 656, a plane 2 660 and a plane 3 664. The memory die 3 670 may include a plane 0 672, a plane 1 676, a plane 2 680 and a plane 3 684. Each of the planes 612, 616, 620, 624, 632, 636, 640, 644, 652, 656, 660, 664, 672, 676, 680 and 684 of the memory dies 610, 630, 650 and 670 included in the memory device 150 may include a plurality of memory blocks 614, 618, 622, 626, 634, 638, 642, 646, 654, 658, 662, 666, 674, 678, 682 and 686. For example, as described earlier with reference to FIG. 2, each of the planes 612, 616, 620, 624, 632, 636, 640, 644, 652, 656, 660, 664, 672, 676, 680 and 684 may include N blocks Block 0 to Block N−1 including a plurality of pages, e.g., 2^{m} pages. Also, the memory device 150 may include a plurality of buffers that respectively correspond to the memory dies 610, 630, 650 and 670. For example, the memory device 150 may include a buffer 0 628 corresponding to the memory die 0 610, a buffer 1 648 corresponding to the memory die 1 630, a buffer 2 668 corresponding to the memory die 2 650, and a buffer 3 688 corresponding to the memory die 3 670.

In accordance with an embodiment of the present invention, during the system operations of the memory system 110, the buffers 628, 648, 668 and 688 included in the memory device 150 may store data regarding the system operations, particularly the meta-data. For example, during system operations, the meta-data corresponding to the system operations may be read from pages of memory blocks included in the memory dies 610, 630, 650 and 670, the read meta-data may be stored into the buffers 628, 648, 668 and 688 and the read meta-data of the buffers 628, 648, 668 and 688 may be stored into the memory 144 of the controller 130 or the UM 510 of the host 102. When the meta-data are updated as a result of performing the system operations in the memory system 110, the updated meta-data may be stored into the buffers 628, 648, 668 and 688 and the updated meta-data of the buffers 628, 648, 668 and 688 may be stored into the pages of memory blocks included in the memory dies 610, 630, 650 and 670.

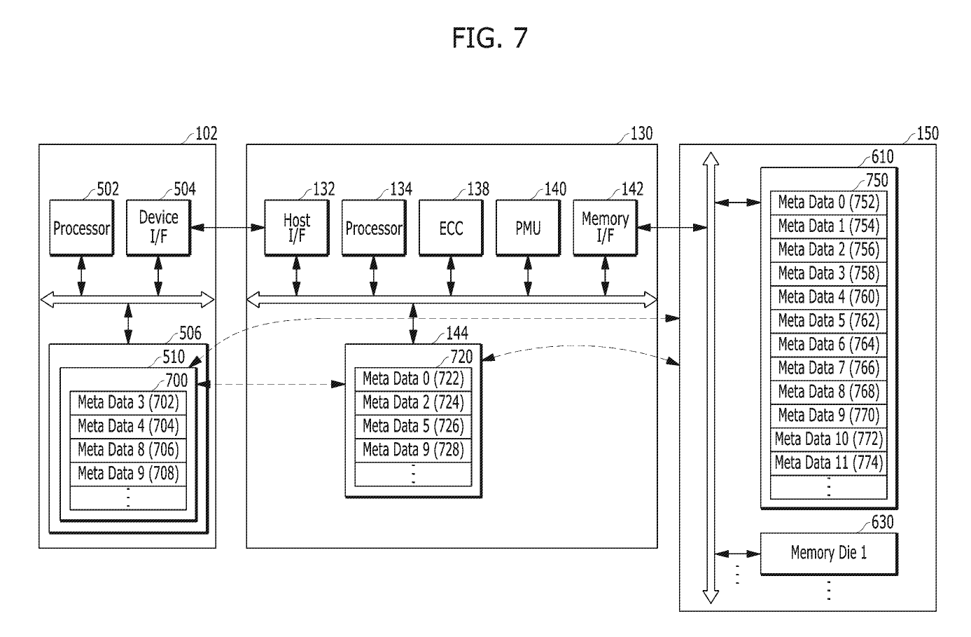

For the sake of convenience in description, it is taken as an example that the buffers 628, 648, 668 and 688 included in the memory device 150 are provided outside the memory dies 610, 630, 650 and 670. In an embodiment, the buffers 628, 648, 668 and 688 included in the memory device 150 may be provided inside the memory dies 610, 630, 650 and 670. In an embodiment, the buffers 628, 648, 668 and 688 may correspond to the planes 612, 616, 620, 624, 632, 636, 640, 644, 652, 656, 660, 664, 672, 676, 680 and 684 or the memory blocks 614, 618, 622, 626, 634, 638, 642, 646, 654, 658, 662, 666, 674, 678, 682 and 686 in the memory dies 610, 630, 650 and 670. For the sake of convenience in description, it is taken as an example that the buffers 628, 648, 668 and 688 included in the memory device 150 are a plurality of page buffers 322, 324 and 326 included in the memory device 150, as described with reference to FIG. 3. However, the buffers 628, 648, 668 and 688 included in the memory device 150 may be a plurality of caches or a plurality of registers included in the memory device 150. Hereafter, with reference to FIG. 7, performing the system operations of the memory system 110 will be described in detail through an example.

Referring to FIG. 7, during the first system operations of the memory system 110, the controller 130 may identify the first meta-data corresponding to the first system operations from the memory 144 of the controller 130, the UM 510 of the host 102 and the memory blocks included in a memory die (e.g., the memory die 0 610) of the memory device 150 by sequentially searching the first meta-data corresponding to the first system operations from the memory 144 of the controller 130, the UM 510 of the host 102 and the memory blocks included in the memory die 0 610 of the memory device 150 in order.

In accordance with an embodiment of the present invention, all meta-data 750 corresponding to the plurality of system operations of the memory system 110 may be stored in memory blocks of the memory device 150 (e.g., memory blocks of the memory die 0 610). In accordance with an embodiment of the present invention, among all meta-data 750 stored in memory blocks of the memory die 0 610, meta-data 720 (e.g., the first meta-data) may be stored in the memory 144 of the controller 130 and another meta-data 700 (e.g., the second meta-data) may be stored in the memory 506 (particularly, the UM 510) of the host 102 according to types, characteristics, usage frequencies and sizes of the meta-data.

In accordance with an embodiment of the present invention, when the first meta-data is stored and thus can be found in the memory 144 of the controller 130, the controller 130 may identify the first meta-data (e.g., meta-data 0 722, meta-data 2 724 and meta-data 5 726) from the memory 144 thereof, perform the first system operations according to the first meta-data (e.g., meta-data 0 722, meta-data 2 724 and meta-data 5 726), and update and store the first meta-data (e.g., meta-data 0 722, meta-data 2 724 and meta-data 5 726) into the memory 144 of the controller 130 and memory blocks of the memory die 0 610 according to a result of performing the first system operations.

In accordance with an embodiment of the present invention, when the first meta-data is not stored and thus cannot be found in the memory 144 of the controller 130, the controller 130 may search the first meta-data from the UM 510 of the host 102. When the first meta-data is stored and thus can be found in the UM 510 of the host 102, the controller 130 may identify the first meta-data (e.g., meta-data 3 702) from the UM 510 of the host 102 and perform the first system operations according to the first meta-data (e.g., meta-data 3 702). In an embodiment, the controller 130 may identify the first meta-data (e.g., meta-data 3 702) from the UM 510 of the host 102. In another embodiment, the controller 130 may identify the first meta-data (e.g., meta-data 3 702) from the memory 144 of the controller 130 by reading the first meta-data (e.g., meta-data 3 702) from the UM 510 of the host 102 and loading the read first meta-data (e.g., meta-data 3 702) onto the memory 144 of the controller 130. In this embodiment, the controller 130 may load onto the memory 144 of the controller 130 whole meta-segments of the first meta-data (e.g., meta-data 3 702) stored in the UM 510 of the host 102 or partial meta-segments required to be identified among the whole meta-segments of the first meta-data (e.g., meta-data 3 702) stored in the UM 510 of the host 102 according to the size of the first meta-data (e.g., meta-data 3 702). The controller 130 may update and store the first meta-data (e.g., meta-data 3 702) into the memory 144 of the controller 130, the UM 510 of the host 102 and memory blocks of the memory die 0 610 according to a result of performing the first system operations.

In accordance with an embodiment of the present invention, when the first meta-data is not stored and thus cannot be found in the UM 510 of the host 102, the controller 130 may search the first meta-data from memory blocks of the memory die 0 610. When the first meta-data is stored and thus can be found in memory blocks of the memory die 0 610, the controller 130 may identify the first meta-data (e.g., meta-data 1 754) from memory blocks of the memory die 0 610 and perform the first system operations according to the first meta-data (e.g., meta-data 1 754). In an embodiment, the controller 130 may identify the first meta-data (e.g., meta-data 1 754) from the memory 144 of the controller 130 or the UM 510 of the host 102 by reading the first meta-data (e.g., meta-data 1 754) from memory blocks of the memory die 0 610 and loading the read first meta-data (e.g., meta-data 1 754) onto the memory 144 of the controller 130 or the UM 510 of the host 102. In this embodiment, the controller 130 may load onto the memory 144 of the controller 130 or the UM 510 of the host 102 whole meta-segments of the first meta-data (e.g., meta-data 1 754) stored in memory blocks of the memory die 0 610 or partial meta-segments required to be identified among the whole meta-segments of the first meta-data (e.g., meta-data 1 754) stored in memory blocks of the memory die 0 610 according to the size of the first meta-data (e.g., meta-data 1 754). The controller 130 may update and store the first meta-data (e.g., meta-data 1 754) into the memory 144 of the controller 130, the UM 510 of the host 102 and memory blocks of the memory die 0 610 according to a result of performing the first system operations.

In accordance with an embodiment of the present invention, during the second system operations of the memory system 110, the controller 130 may identify the second meta-data corresponding to the second system operations from the UM 510 of the host 102 and the memory blocks included in a memory die (e.g., the memory die 0 610) of the memory device 150 by sequentially searching the second meta-data corresponding to the second system operation from the UM 510 of the host 102 and the memory blocks included in the memory die 0 610 of the memory device 150 in order.

In accordance with an embodiment of the present invention, when the second meta-data is stored and thus can be found in the UM 510 of the host 102, the controller 130 may identify the second meta-data (e.g., meta-data 4 704 and meta-data 8 706) from the UM 510 of the host 102, perform the second system operations according to the second meta-data (e.g., meta-data 4 704 and meta-data 8 706). In an embodiment, the controller 130 may identify the second meta-data (e.g., meta-data 4 704 and meta-data 8 706) from the memory 144 of the controller 130 by reading the second meta-data (e.g., meta-data 4 704 and meta-data 8 706) from the UM 510 of the host 102 and loading the read second meta-data (e.g., meta-data 4 704 and meta-data 8 706) onto the memory 144 of the controller 130. In this embodiment, the controller 130 may load onto the memory 144 of the controller 130 whole meta-segments of the second meta-data (e.g., meta-data 4 704 and meta-data 8 706) stored in the UM 510 of the host 102 or partial meta-segments required to be identified among the whole meta-segments of the second meta-data (e.g., meta-data 4 704 and meta-data 8 706) stored in the UM 510 of the host 102 according to the size of the second meta-data (e.g., meta-data 4 704 and meta-data 8 706). The controller 130 may update and store the second meta-data (e.g., meta-data 4 704 and meta-data 8 706) into the UM 510 of the host 102 and memory blocks of the memory die 0 610 according to a result of performing the second system operations.

In accordance with an embodiment of the present invention, when the second meta-data is not stored and thus cannot be found in the UM 510 of the host 102, the controller 130 may search the second meta-data from memory blocks of the memory die 0 610. When the second meta-data is stored and thus can be found in memory blocks of the memory die 0 610, the controller 130 may identify the second meta-data (e.g., meta-data 6 764) from memory blocks of the memory die 0 610 and perform the second system operations according to the second meta-data (e.g., meta-data 6 764). In an embodiment, the controller 130 may identify the second meta-data (e.g., meta-data 6 764) from the memory 144 of the controller 130 or the UM 510 of the host 102 by reading the second meta-data (e.g., meta-data 6 764) from memory blocks of the memory die 0 610 and loading the read second meta-data (e.g., meta-data 6 764) onto the memory 144 of the controller 130 or the UM 510 of the host 102. In this embodiment, the controller 130 may load onto the memory 144 of the controller 130 or the UM 510 of the host 102 whole meta-segments of the second meta-data (e.g., meta-data 6 764) stored in memory blocks of the memory die 0 610 or partial meta-segments required to be identified among the whole meta-segments of the second meta-data (e.g., meta-data 6 764) stored in memory blocks of the memory die 0 610 according to the size of the second meta-data (e.g., meta-data 6 764). The controller 130 may update and store the second meta-data (e.g., meta-data 6 764) into the memory 144 of the UM 510 of the host 102 and memory blocks of the memory die 0 610 according to a result of performing the second system operations.

In accordance with an embodiment of the present invention, during the third system operations of the memory system 110, the controller 130 may identify the third meta-data corresponding to the third system operations from the memory blocks included in a memory die (e.g., the memory die 0 610) of the memory device 150.

In accordance with an embodiment of the present invention, the controller 130 may identify the third meta-data (e.g., meta-data 10 772 and meta-data 11 774) from memory blocks of the memory die 0 610 and perform the third system operations according to the third meta-data (e.g., meta-data 10 772 and meta-data 11 774). In an embodiment, the controller 130 may identify the third meta-data (e.g., meta-data 10 772 and meta-data 11 774) from the memory 144 of the controller 130 or the UM 510 of the host 102 by reading the third meta-data (e.g., meta-data 10 772 and meta-data 11 774) from memory blocks of the memory die 0 610 and loading the read third meta-data (e.g., meta-data 10 772 and meta-data 11 774) onto the memory 144 of the controller 130 or the UM 510 of the host 102. In this embodiment, the controller 130 may load onto the memory 144 of the controller 130 or the UM 510 of the host 102 whole meta-segments of the third meta-data (e.g., meta-data 10 772 and meta-data 11 774) stored in memory blocks of the memory die 0 610 or partial meta-segments required to be identified among the whole meta-segments of the third meta-data (e.g., meta-data 10 772 and meta-data 11 774) stored in memory blocks of the memory die 0 610 according to the size of the third meta-data (e.g., meta-data 10 772 and meta-data 11 774). The controller 130 may update and store the third meta-data (e.g., meta-data 10 772 and meta-data 11 774) into memory blocks of the memory die 0 610 according to a result of performing the third system operations.

In accordance with an embodiment of the present invention, during the fourth system operations of the memory system 110, the controller 130 may identify the fourth meta-data corresponding to the fourth system operations from the memory blocks included in a memory die (e.g., the memory die 0 610) of the memory device 150.

In accordance with an embodiment of the present invention, the controller 130 may identify the fourth meta-data (e.g., meta-data 7 766) from memory blocks of the memory die 0 610 and perform the fourth system operations according to the fourth meta-data (e.g., meta-data 7 766). In an embodiment, the controller 130 may identify the fourth meta-data (e.g., meta-data 7 766) from the memory 144 of the controller 130 or the UM 510 of the host 102 by reading the fourth meta-data (e.g., meta-data 7 766) from memory blocks of the memory die 0 610 and loading the read fourth meta-data (e.g., meta-data 7 766) onto the memory 144 of the controller 130 or the UM 510 of the host 102. In this embodiment, the controller 130 may load onto the memory 144 of the controller 130 or the UM 510 of the host 102 whole meta-segments of the fourth meta-data (e.g., meta-data 7 766) stored in memory blocks of the memory die 0 610 or partial meta-segments required to be identified among the whole meta-segments of the fourth meta-data (e.g., meta-data 7 766) stored in memory blocks of the memory die 0 610 according to the size of the fourth meta-data (e.g., meta-data 7 766). The controller 130 may not update the fourth meta-data (e.g., meta-data 7 766) according to a result of performing the fourth system operations since the fourth meta-data is of a one-time usage frequency.

In accordance with an embodiment of the present invention, the controller 130 may further classify the meta-data as a fifth meta-data instead of the first to fourth meta-data according to types, characteristics, usage frequencies and sizes of the meta-data as described above. The fifth meta-data may be of a short term, have a greater size than the threshold size range and of high usage frequency. The fifth meta-data may include the first and second meta-data.

In accordance with an embodiment of the present invention, the controller 130 may store the fifth meta-data into the memory 144 thereof and the UM 510 of the host 102 as well as memory blocks of a memory die (e.g., the memory die 0 610) of the memory device 150. For example, the controller 130 may store the fifth meta-data (e.g., meta-data 9 770) into memory blocks of the memory die 0 610.

In accordance with an embodiment of the present invention, among meta-segments of the fifth meta-data (e.g., meta-data 9 770) stored in memory blocks of the memory die 0 610, the controller 130 may store meta data 9 728 of the meta-data 9 770 into the memory 144 thereof and store meta data 9 708 of the meta-data 9 770 into the UM 510 of the host 102. The meta data 9 728 stored in the memory 144 of the controller 130 and the meta data 9 708 stored in the UM 510 of the host 102 may be managed according to a result of performing fifth system operations corresponding to the fifth meta-data (e.g., meta-data 9 770). The meta data 9 728 stored in the memory 144 of the controller 130 and the meta data 9 708 stored in the UM 510 of the host 102 may be managed according to least recently used (LRU)/most recently used (MRU) scheme.

During the fifth system operations of the memory system 110, the controller 130 may identify the meta-segments of the fifth meta-data (e.g., meta-data 9 770) corresponding to the fifth system operations from the memory 144 of the controller 130, the UM 510 of the host 102 and the memory blocks included in a memory die (e.g., the memory die 0 610) of the memory device 150 by sequentially searching the meta-segments of the fifth meta-data (e.g., meta-data 9 770) corresponding to the fifth system operations from the memory 144 of the controller 130, the UM 510 of the host 102 and the memory blocks included in the memory die 0 610 of the memory device 150 in order.

In accordance with an embodiment of the present invention, when the meta-segments of the fifth meta-data (e.g., meta-data 9 770) are stored and thus can be found in the memory 144 of the controller 130, the controller 130 may identify the meta data 9 728 of the meta-data 9 770 from the memory 144 thereof, perform the fifth system operations according to the fifth meta-data (e.g., meta-data 9 770), and update and store the fifth meta-data (e.g., meta-data 9 770) into the memory 144 of the controller 130, the UM 510 of the host 102 and memory blocks of the memory die 0 610 according to a result of performing the fifth system operations.

In accordance with an embodiment of the present invention, when the meta-segments of the fifth meta-data are not stored and thus cannot be found in the memory 144 of the controller 130, the controller 130 may search the meta-segments of the fifth meta-data from the UM 510 of the host 102. When the meta-segments of the fifth meta-data are stored and thus can be found in the UM 510 of the host 102, the controller 130 may identify the meta-segments (e.g., the meta data 9 708) of the fifth meta-data from the UM 510 of the host 102 and perform the fifth system operations according to the fifth meta-data. In an embodiment, the controller 130 may identify the meta data 9 708 of the fifth meta-data from the UM 510 of the host 102. In another embodiment, the controller 130 may identify the meta data 9 708 of the fifth meta-data from the memory 144 of the controller 130 by reading the meta data 9 708 of the fifth meta-data from the UM 510 of the host 102 and loading the meta data 9 708 of the fifth meta-data onto the memory 144 of the controller 130. The controller 130 may update and store the fifth meta-data into the memory 144 of the controller 130, the UM 510 of the host 102 and memory blocks of the memory die 0 610 according to a result of performing the fifth system operations.

In accordance with an embodiment of the present invention, when the meta-segments of the fifth meta-data is not stored and thus cannot be found in the UM 510 of the host 102, the controller 130 may search the fifth meta-data from memory blocks of the memory die 0 610. When the fifth meta-data is stored and thus can be found in memory blocks of the memory die 0 610, the controller 130 may identify the fifth meta-data (e.g., meta-data 9 770) from memory blocks of the memory die 0 610 and perform the fifth system operations according to the fifth meta-data (e.g., meta-data 9 770). In an embodiment, the controller 130 may identify the fifth meta-data (e.g., meta-data 9 770) from the memory 144 of the controller 130 or the UM 510 of the host 102 by reading the fifth meta-data (e.g., meta-data 9 770) from memory blocks of the memory die 0 610 and loading the read fifth meta-data (e.g., meta-data 9 770) onto the memory 144 of the controller 130 or the UM 510 of the host 102. In this embodiment, the controller 130 may load onto the memory 144 of the controller 130 or the UM 510 of the host 102 partial meta-segments required to be identified among the whole meta-segments of the fifth meta-data (e.g., meta-data 9 770) stored in memory blocks of the memory die 0 610. The controller 130 may update and store the fifth meta-data (e.g., meta-data 9 770) into the memory 144 of the controller 130, the UM 510 of the host 102 and memory blocks of the memory die 0 610 according to a result of performing the fifth system operations.

In accordance with an embodiment of the present invention, during such plurality of system operations, the controller 130 may identify the meta-data corresponding to the system operations by searching the meta-data corresponding to the system operations from the memory 144 of the controller 130, the memory of the host 102 and memory blocks of the memory device 150, perform the system operations according to the meta-data, and update and store the meta-data into the memory 144 of the controller 130, the memory of the host 102 or the memory blocks of the memory device 150 according to a result of performing the system operations.

In accordance with an embodiment of the present invention, the controller 130 may randomize or scramble the meta-data, which is to be stored in the UM 510 of the host 102, for encryption of the meta-data while storing the meta-data into the UM 510 of the host 102. In accordance with an embodiment of the present invention, data of the memory system 110 may be stored in the UM 510 of the host 102 thereby expanding memory space of the memory system 110.

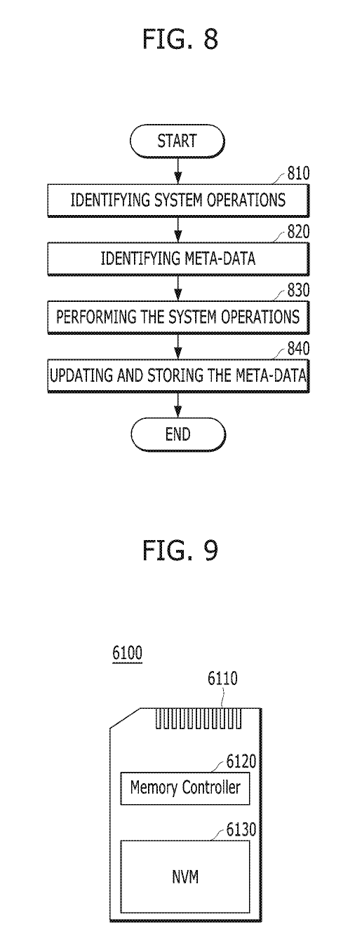

In accordance with an embodiment of the present invention, memory space for the controller 130 may be expanded from the memory 144 thereof to the UM 510 of the host 102. Accordingly, operation performance of the memory system 110 may be improved. In accordance with an embodiment of the present invention, data of the memory system 110 may be secured through encryption of data to be stored in the memory of the host 102. Accordingly, reliability and security of the memory system 110 may be improved. Hereafter, performing the system operation by the memory system 110 in accordance with the embodiments of the present invention is described in detail with reference to FIG. 8.

FIG. 8 is a flowchart illustrating an operation of processing meta-data regarding a plurality of system operations in the memory system 110 in accordance with the embodiment of the present invention.

Referring to FIG. 8, at step 810, the memory system 110 may identify system operations. The system operations may include foreground operations including a plurality of command operations for a plurality of commands provided from the host 102; background operations including a garbage collection operation, a wear-leveling operation, a map flush operation, a bad block management operation, and so forth; and other operations like a booting operation, an initialization operation, a trim operation, and so forth when the memory system 110 illustrated in FIG. 1 performs the plurality of system operations.

At step 820, the memory system 110 may identify meta-data corresponding to the system operations. The meta-data may be identified from the memory 144 of the controller 130 and the UM 510 of the host 102 as well as memory blocks of the memory device 150 included in the memory system 110.

At step 830, the memory system 110 may perform the system operations according to the meta-data. At step 840, the memory system 110 may update and store the meta-data into the memory 144 of the controller 130 and the UM 510 of the host 102 as well as memory blocks of the memory device 150 included in the memory system 110 according to a result of performing the system operations.

Since the identifying of the meta-data corresponding to the system operations from the memory 144 of the controller 130 and the UM 510 of the host 102 as well as memory blocks of the memory device 150 included in the memory system 110; the performing of the system operations according to the meta-data; and the updating and storing of the meta-data into the memory 144 of the controller 130 and the UM 510 of the host 102 as well as memory blocks of the memory device 150 included in the memory system 110 according to a result of performing the system operations is described earlier with reference to FIGS. 5 to 7, further description on it will be omitted herein.

FIGS. 9 to 17 are diagrams schematically illustrating application examples of the data processing system of FIGS. 1 to 8 according to various embodiments.

FIG. 9 is a diagram schematically illustrating another example of the data processing system including the memory system in accordance with the present embodiment. FIG. 9 schematically illustrates a memory card system to which the memory system in accordance with the present embodiment is applied.

Referring to FIG. 9, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 to 8, and the memory device 6130 may correspond to the memory device 150 of the memory system 110 described with reference to FIGS. 1 to 8.

Thus, the memory controller 6120 may include a RAM, a processing unit, a host interface, a memory interface and an error correction unit. The memory controller 130 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

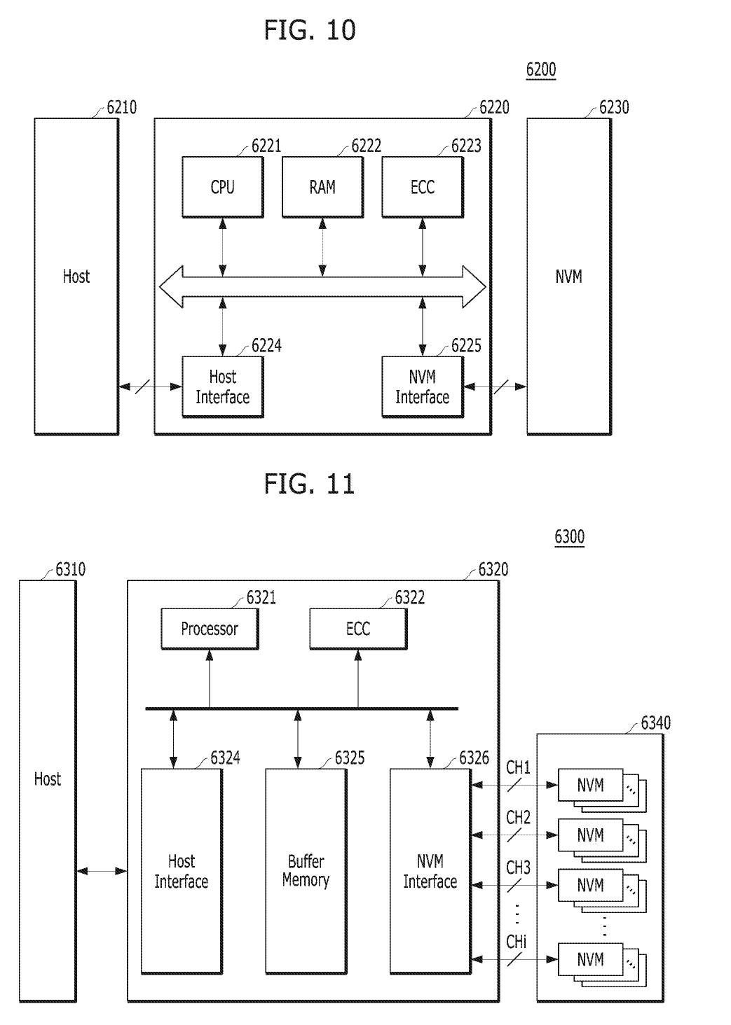

FIG. 10 is a diagram schematically illustrating another example of the data processing system including a memory system, in accordance with the present embodiment.

Referring to FIG. 10, the data processing system 6200 may include a memory device 6230 having one or more nonvolatile memories and a memory controller 6220 for controlling the memory device 6230. The data processing system 6200 illustrated in FIG. 10 may serve as a storage medium such as a memory card (CF, SD, micro-SD or the like) or USB device, as described with reference to FIG. 1. The memory device 6230 may correspond to the memory device 150 in the memory system 110 described in FIGS. 1 to 8, and the memory controller 6220 may correspond to the controller 130 in the memory system 110 described in FIGS. 1 to 8.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NIM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

FIG. 11 is a diagram schematically illustrating another example of the data processing system including the memory system in accordance with the present embodiment. FIG. 11 schematically illustrates an SSD to which the memory system in accordance with the present embodiment is applied.

Referring to FIG. 11, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta-data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 11 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

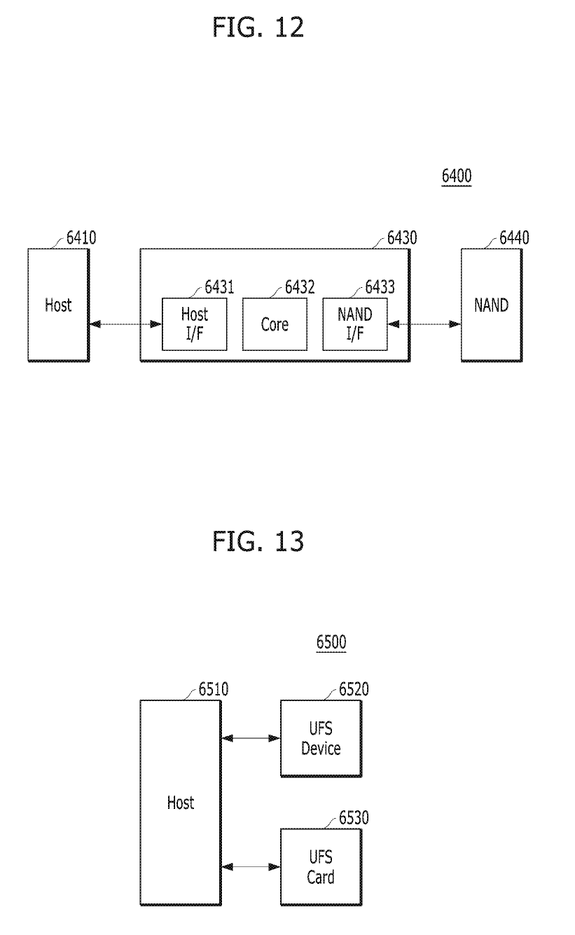

FIG. 12 is a diagram schematically illustrating another example of the data processing system including the memory system in accordance with an embodiment. FIG. 12 schematically illustrates an embedded Multi-Media Card (eMMC) to which the memory system in accordance with an embodiment is applied.

Referring to FIG. 12, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control the operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

FIGS. 13 to 16 are diagrams schematically illustrating other examples of the data processing system including the memory system in accordance with an embodiment. FIGS. 13 to 16 schematically illustrate UFS (Universal Flash Storage) systems to which the memory system in accordance with an embodiment is applied.

Referring to FIGS. 13 to 16, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 10 to 12, and the UFS cards 6530, 6630, 6730 and 6830 may be embodied in the form of the memory card system 6100 described with reference to FIG. 9.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 13, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

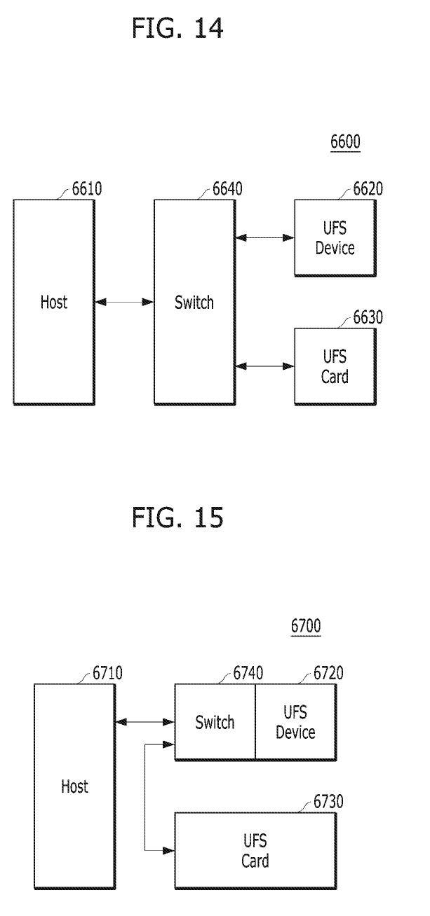

In the UFS system 6600 illustrated in FIG. 14, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

In the UFS system 6700 illustrated in FIG. 15, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

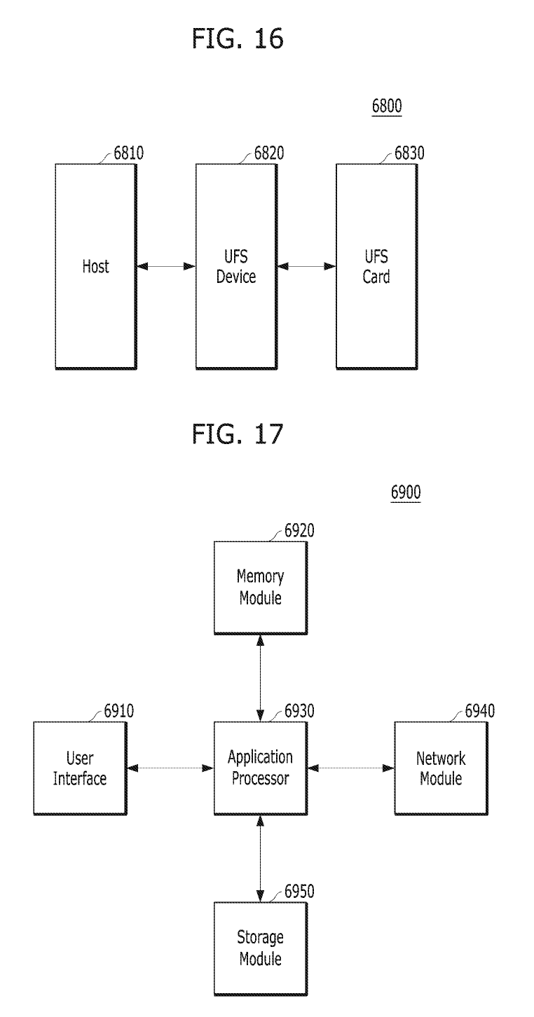

In the UFS system 6800 illustrated in FIG. 16, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

FIG. 17 is a diagram schematically illustrating another example of the data processing system including the memory system in accordance with an embodiment. FIG. 17 is a diagram schematically illustrating a user system to which the memory system in accordance with an embodiment is applied.

Referring to FIG. 17, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 11 to 16.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a memory device suitable for storing data; and
a controller including a first memory,
wherein the controller is suitable for:
performing system operations to the memory device and the controller;
storing meta-data corresponding to the system operations into the memory device;
storing the meta-data stored in the memory device into one or more between the first memory and a second memory included in a host; and
identifying the meta-data from the memory device, the first memory and the second memory when performing the system operations.

2. The memory system of claim 1, wherein the controller is suitable for, when performing first system operations among the system operations:
identifying first meta-data corresponding to the first system operations from the first memory; and
identifying, when the first meta-data is not identified from the first memory, the first meta-data from the second memory.

3. The memory system of claim 2, wherein the controller is suitable for, when the first meta-data is not identified from the second memory, reading the first meta-data from the memory device and storing the first meta-data into the first memory and the second memory.

4. The memory system of claim 3, wherein the controller is suitable for reading from the second memory the first meta-data identified from the second memory, and storing the first meta-data into the first memory.

5. The memory system of claim 4, wherein the controller is suitable for reading whole meta-segments or partial meta-segments required to be identified for performing the first system operations among meta-segments of the first meta-data according to a size of the first meta-data, and storing the read meta-segments into the first memory or the second memory.

6. The memory system of claim 3, wherein the controller is suitable for performing the first system operations according to the first meta-data after identifying the first meta-data from the first memory or the second memory.

7. The memory system of claim 6, wherein the controller is suitable for:
updating the first meta-data according to a result of performing the first system operations; and
storing the updated first meta-data into the memory device and one or more between the first memory and the second memory.

8. The memory system of claim 1, wherein the controller is suitable for storing the meta-data into one or more between the first memory and the second memory according to one or more among types, characteristics, usage frequencies and sizes of the meta-data.

9. The memory system of claim 1, wherein the meta-data includes one or more among map data, count information, table information, meta-information, statistical information and one-time usage frequency meta-data.

10. The memory system of claim 1, wherein the controller is suitable for:
encrypting the meta-data and storing the encrypted meta-data into the second memory; and
identifying the encrypted meta-data stored in the second memory by decrypting the encrypted meta-data.

11. An operating method of a memory system, the method comprising:
performing system operations to a memory device suitable for storing data and a controller of the memory device; and
storing meta-data corresponding to the system operations into the memory device, and storing the meta-data stored in the memory device into one or more between a first memory included in the controller and a second memory included in a host,
wherein the performing of the system operations includes identifying the meta-data from the memory device, the first memory and the second memory.

12. The method of claim 11, wherein the performing of the system operations further includes, when performing first system operations among the system operations:
identifying first meta-data corresponding to the first system operations from the first memory; and
identifying, when the first meta-data is not identified from the first memory, the first meta-data from the second memory.

13. The method of claim 12, further comprising, when the first meta-data is not identified from the second memory, reading the first meta-data from the memory device and storing the first meta-data into the first memory and the second memory.

14. The method of claim 13, further comprising reading from the second memory the first meta-data identified from the second memory, and storing the first meta-data into the first memory.

15. The method of claim 14, further comprising reading whole meta-segments or partial meta-segments required to be identified for performing the first system operations among meta-segments of the first meta-data according to a size of the first meta-data, and storing the read meta-segments into the first memory or the second memory.

16. The method of claim 13, further comprising performing the first system operations according to the first meta-data after identifying the first meta-data from the first memory or the second memory.

17. The method of claim 16, further comprising:
updating the first meta-data according to a result of performing the first system operations; and
storing the updated first meta-data into the memory device and one or more between the first memory and the second memory.

18. The method of claim 11, wherein the storing of the meta-data includes storing the meta-data into one or more between the first memory and the second memory according to one or more among types, characteristics, usage frequencies and sizes of the meta-data.

19. The method of claim 11, wherein the meta-data includes one or more among map data, count information, table information, meta-information, statistical information and one-time usage frequency meta-data.

20. The method of claim 11, wherein the storing of the meta-data includes encrypting the meta-data and storing the encrypted meta-data into the second memory, and wherein the identifying of the meta-data includes identifying the encrypted meta-data stored in the second memory by decrypting the encrypted meta-data.

21. A data processing system comprising:
a memory device storing meta-data related to a system operation;
a controller suitable for controlling the memory device to perform the system operation according to the meta-data loaded from the memory device onto a first memory included therein; and
a host including a second memory shared with the controller and suitable for requesting to the controller a memory operation,
wherein the controller is further suitable for using the second memory as a cache memory for the meta-data while in operation.
